(19) United States
(12) Patent Application Publication
(10) Pub. No.: US 2005/0118346 A1
(43) Pub. Date: Jun. 2, 2005

(54) Method for manufacturing a glow pin for a ceramic glow plug

(75) Inventors: Oliver Goeb, Marbach (DE); Hans Houben, Wuerselen (DE); Lutz Frassek, Roedental (DE); Henning Von Watzdorf, Ludwigsburg (DE); Martin Allgaier, Ludwigsburg (DE)

Correspondence Address: NIXON PEABODY, LLP, 401 9TH STREET, NW, SUITE 900, WASHINGTON, DC, 20004-2128, US

(73) Assignee: Beru AG, Ludwigsburg (DE)

(21) Appl. No.: 10/984,882

(22) Filed: Nov. 10, 2004

(30) Foreign Application Priority Data
Nov. 19, 2003 (DE) 103 53 973.5

(51) Int. Cl. H05H 1/26

(52) U.S. Cl. 427/446

(57) ABSTRACT

A method for manufacturing a glow pin for a ceramic glow plug which is constructed of an inner cylinder and at least one outer layer that is coaxial to the inner cylinder and/or a base layer or cover layer on the front face. The at least one coaxial outer layer and/or the front-face layer is formed by thermal spraying.

### BACKGROUND OF THE INVENTION

1. Field of Invention

The invention relates to a method for manufacturing a glow pin for a ceramic glow plug which is constructed of an inner cylinder and at least one outer layer.

2. Description of Related Art

A glow pin or a glow plug with such a glow pin is known, for example, from U.S. Pat. No. 6,309,859 or German Patent Application DE 100 53 372 A1.

With the shaping methods hitherto conventional for manufacturing such a glow pin, such as dry pressing, injection molding and slip casting, the thin layers necessary for the functionality can only be achieved at great expense. In addition, the shaping process is followed by another cost-intensive sintering process.

### SUMMARY OF THE INVENTION

The object forming the basis of the invention is thus to provide a method of the type specified initially with which a glow pin can be manufactured cheaply.

This object is solved according to the invention by the fact that the at least one outer layer is formed by thermal spraying.

The at least one outer layer can be an outer layer coaxial to the inner cylinder and/or a layer covering the front face of the inner cylinder.

If the at least one outer layer, especially the coaxial outer layer and/or the layer covering the front face of the inner cylinder, is formed by thermal spraying, the result is a manufacturing method in which simple and cheap shaping and consolidation methods are interlinked.

Especially preferred exemplary embodiments of the method according to the invention are explained in detail subsequently with reference to the accompanying drawings.

### BRIEF DESCRIPTION OF THE DRAWINGS

FIG. 1 is a schematic sectional view of a glow pin for a ceramic glow plug,

FIG. 2 shows the process step of thermal spraying of an outer layer in a schematic sectional view and

FIG. 3 shows the process step of final processing of the glow pin in a schematic sectional view.

### DETAILED DESCRIPTION OF THE INVENTION

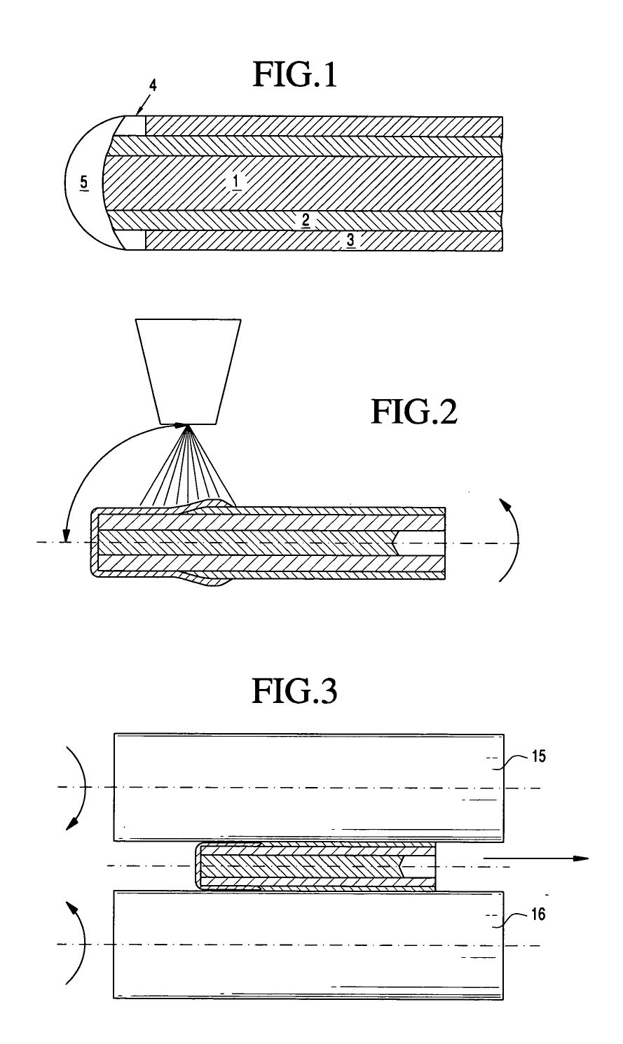

FIG. 1 is a sectional view showing a glow pin for a ceramic glow plug which has an electrically conducting inner cylinder 1, an insulating layer 2 provided coaxial to the inner cylinder 1 at its cylindrical outer surface, a conductive layer 3 provided coaxially thereto and heating layers 4, 5 which are constructed as a coaxial layer 4 and a layer 5 running perpendicular to the axis of the glow pin at the end of the arrangement comprising inner cylinder 1 and layers 2, 3.

The inner cylinder 1 is formed, for example, by uniaxial dry pressing, if necessary with cold-isostatic post-compaction, by extrusion or by powder injection molding. The inner cylinder is then subjected to binder removal and is pre-sintered or compactly sintered in order to give it sufficient strength for the following operations.

After calibrating the diameter and cutting the inner cylinder to length, it is tapered at one end by a machining process or by water jets, and is provided at the other end with a contact hole. These operations can be carried out before the binder removal and pre-sintering or after the binder removal and pre-sintering by white processing using a diamond tool.

The outer layers are then applied by thermal spraying on to the inner cylinder 1.

In a further exemplary embodiment, the conducting inner cylinder 1 and the insulating layer 2 are produced by the shaping method described above and the conductive layer 3 and the layer 5 running perpendicular to the glow pin axis and if necessary, the coaxial layer 4 which is constructed thereon, are thermally sprayed.

Furthermore, it is also possible to produce the conducting inner cylinder 1, the insulating layer 2 and the conductive layer 3 by the shaping method described and to only form the layer 5 running perpendicular to the glow pin axis, and if necessary the coaxial layer 4, by thermal spraying.

The thermal spraying takes place preferably after the pre-sintering or sintering of the components. Especially suitable as thermal spraying methods are atmospheric plasma spraying (APS), vacuum plasma spraying (VPS) and high-velocity flame spraying (HVOF).

In order to avoid thermal stresses during application of the layers, for this purpose, the blank is heated during the spraying. If the surface roughness of the blank is not sufficient for adequate adhesion of the layer to be sprayed on, the surface is roughened mechanically or by another method before the coating. An adhesion promoter can also be sprayed on which can also be used to match the coefficients of thermal expansion of the materials of the inner cylinder 1 and the individual layers 2, 3, 4, 5, one to the other.

In addition, a hardening treatment, e.g., beveling the pin-shaped blank, can take place before spraying. Moreover, as a result of the hardening treatment, a better classification of the individual functional layers can be achieved in order to avoid hot spots.

An insulating layer can also be thermally sprayed onto the outer layer 3 so that this structure makes it possible to use a glow plug with such a ceramic glow pin as an ion current measuring plug.

The electrical functional layers can be thermally sprayed onto a pre-sintered base cylinder wherein, in this case, the final compaction only takes place in a subsequent gas-pressure sintering process.

As shown in FIG. 2, the ceramic functional layers are thus applied to the sintered raw cylinder by means of a thermal spraying method. In this situation, the layer structure is rotationally symmetrical and is contacted by an outer pole and an inner pole.

The hard treatment of the glow pin can then take place after the pre-sintering or sintering or after the thermal spraying, for example, by a simple and cheap push-through grinding process, as shown in FIG. 3. In this case, the glow pin is ground to its final geometry which is accomplished by means of a pressure roller 15 and a grinding wheel 16. The direction of movement and turning of the tool and the glow pin to be processed are shown by the arrows in FIG. 3.

Especially suited as the material for the inner cylinder 1 and the layers 2 to 5 are silicide, carbide, nitride or boride materials. Oxides, such as Al₂O₃ and Y₂O₃, and in general, oxides of rare-earth metals can be used as sinter additives.

During spraying, the thermal powder can be present both as a pure powder mixture and as already sintered granules. The melt phase required for thermal spraying can be produced by adding fusible semiconductor or metallic components, such as silicon. In a further exemplary embodiment a powder coated with a fusible phase can be used for thermal spraying.

1. A method for manufacturing a glow pin for a ceramic glow plug which is constructed of an inner cylinder and at least one outer layer, wherein the at least one outer layer is formed by thermal spraying.

2. The method according to claim 1, wherein the at least one outer layer is coaxial to the inner cylinder.

3. The method according to claim 1, wherein the at least one outer layer is a layer covering the inner cylinder on a front face thereof.

4. The method according to claim 1, wherein coefficients of thermal expansion of the material of the inner cylinder and of the materials of the outer layer are matched to one another by thermally spraying on intermediate layers with corresponding expansion coefficients.

5. The method according to claim 1, wherein the surface on which the at least one outer layer is to be sprayed is roughened before spraying.

6. The method according to claim 1, wherein said thermal spraying is one of a atmospheric plasma spraying (APS), vacuum plasma spraying (VPS) and high-velocity flame spraying (HVOF) process.

7. The method according to claim 1, wherein the thermal spraying takes place on a rod which is constructed of the inner cylinder and at least one layer coaxial thereto, and wherein the rod is formed by co-extrusion of the inner cylinder and the at least one coaxial layer.

8. The method according to claim 1, wherein the inner cylinder is pre-sintered and a final compaction is produced by gas-pressure sintering after the thermal spraying of the at least one outer layer.

9. The method according to claim 7, wherein the rod is compactly sintered and after the thermal spraying onto the compactly sintered rod, a thermal treatment takes place to eliminate residual porosity of the at least one thermally sprayed layer.

10. The method according to claim 1, wherein the inner cylinder and at least one outer layer are formed of a material selected from the group consisting of suicides, nitrides, carbides and borides.

11. The method according to claim 1, wherein the inner cylinder is subjected to a hardening treatment prior to thermally spraying on the at least one outer layer.
